(19) United States
(12) Patent Application Publication
(10) Pub. No.: US 2026/0133038 A1
(43) Pub. Date: May 14, 2026

(54) METHOD AND SYSTEM FOR PROVIDING RESPONSE PLAN BASED ON ROUTE OF EMERGENCY VEHICLE

(71) Applicants: Hyundai Motor Company, Seoul (KR); Kia Corporation, Seoul (KR)

(72) Inventor: Tae Heon Kim, Hwaseong (KR)

(21) Appl. No.: 19/198,793

(22) Filed: May 5, 2025

(30) Foreign Application Priority Data
Nov. 13, 2024 (KR) 10-2024-0161179

(51) Int. Cl. G01C 21/34

(52) U.S. Cl. CPC G01C 21/3415

(57) ABSTRACT

A method and system are configured to provide a response plan based on an expected moving route of an emergency vehicle. The method includes determining whether routes of a user vehicle and an emergency vehicle overlap based on a destination route and current location information received from the user vehicle and current location information, a route sequence, and traffic information of the emergency vehicle received from an emergency vehicle server, and providing an avoidance route to the user vehicle or providing a responding driving plan to the user vehicle, the responding driving plan being provided based on an Estimated Time of Arrival (ETA) to a destination of the user vehicle and information on an estimated driving lane of the emergency vehicle.

### CROSS REFERENCE TO RELATED APPLICATION

The present application claims under 35 U.S.C. § 119(a) the benefit of Korean Patent Application No. 10-2024-0161179, filed Nov. 13, 2024, the entire contents of which are incorporated by reference herein.

### BACKGROUND

### (a) Technical Field

The present disclosure relates to a method and system for providing a response plan based on a route of an emergency vehicle, more particularly, to the method and system for providing the response plan based on an expected movement route of the emergency vehicle.

### (b) Background

An ambulance or a fire engine is a vehicle that is used in an emergency situation or a disaster to save human lives or extinguish a fire. In cases where a medical emergency occurs or a fire breaks out, initial response or early suppression is very important. Therefore, it is preferable that an emergency vehicle sounds a siren to signal an approach, and a general driver or a pedestrian recognizes the approach of emergency vehicle through the siren and then moves to a safe position or yields to allow the emergency vehicle to pass.

Recently, a route provision technology capable of providing a route that avoids an emergency vehicle in consideration of a location of the emergency vehicle has been developed. However, the location of the emergency vehicle moves in real time, and there is inevitably a situation in which a user's driving route and a driving route of the emergency vehicle overlap. For this reason, when a traffic jam occurs, the environment is different from a general traffic jam situation, so that an error in a prediction of an Estimated Time of Arrival (ETA) is bound to occur by a general ETA prediction technology. In addition, when an emergency vehicle approaches from behind a driver, the driver may panic and fail to take an appropriate action.

Therefore, a technology that provides a necessary response plan to a user based on an overlap analysis between an emergency vehicle and a user vehicle, and that predicts an ETA by reflecting the influence of the emergency vehicle is required.

### SUMMARY

Accordingly, the present disclosure has an objective to provide a necessary response plan based on a complex analysis between a route of an emergency vehicle and a route of a user vehicle.

Another objective of the present disclosure is to predict an Estimated Time of Arrival (ETA) by reflecting the influence of an emergency vehicle.

The technical problems to be solved by the present disclosure are not limited to the above-mentioned problems, and other problems which are not mentioned will be clearly understood by those skilled in the art from the following description. In order to achieve the objectives of the present disclosure, according to an aspect of the present disclosure, there is provided a method for providing an emergency vehicle response plan, the method including: a) determining, by a controller, whether a route of a user vehicle and a route of an emergency vehicle overlap; and b) providing, by the controller, i) an avoidance route to the user vehicle and/or ii) a responding driving plan to the user vehicle, the responding driving plan being provided based on an Estimated Time of Arrival (ETA) to a destination of the user vehicle. Suitably, overlap of the user vehicle route and emergency vehicle route may be determined based on i) a destination route and current location information received from the user vehicle and ii) current location information, a route sequence, and/or traffic information of the emergency vehicle received from an emergency vehicle.

In a further aspect, a method for providing an emergency vehicle response plan is provided, the method comprising: determining such as by a controller whether a route of a user vehicle and a route of an emergency vehicle overlap based on a destination route and current location information received from the user vehicle and based on current location information, a route sequence, and traffic information of the emergency vehicle received from an emergency vehicle server; and providing such as by a controller an avoidance route to the user vehicle or providing a responding driving plan to the user vehicle (e.g., according to whether the user vehicle is capable of using the avoidance route in response that the route of the user vehicle and the route of the emergency vehicle overlap), the responding driving plan being provided based on an Estimated Time of Arrival (ETA) to a destination of the user vehicle and information on an estimated driving lane of the emergency vehicle.

For example, the information on the estimated driving lane of the emergency vehicle may be determined based on sensor information received from a vehicle around the user vehicle.

For example, the method may further include generating an avoidance route in which the user vehicle is capable of reaching the destination while avoiding the emergency vehicle in response that a route for avoiding the emergency vehicle is capable of being used.

For example, the determining of whether the route of the user vehicle and the route of the emergency vehicle overlap may include determining whether a first condition regarding whether the user vehicle is located in front of the emergency vehicle on the route sequence of the emergency vehicle is satisfied.

For example, the determining of whether the route of the user vehicle and the route of the emergency vehicle overlap may further include determining whether a second condition regarding whether the emergency vehicle is capable of passing the user vehicle before the user vehicle passes the route sequence of the emergency vehicle is satisfied.

For example, whether the emergency vehicle is capable of passing the user vehicle before the user vehicle passes the route sequence of the emergency vehicle may be determined based on a result of comparing a remaining time until the user vehicle passes the route sequence of the emergency vehicle with a remaining time until the emergency vehicle passes the route sequence.

For example, the remaining time until the user vehicle passes the route sequence of the emergency vehicle may be determined based on an average speed of the user vehicle and a remaining distance of a forward section remaining before the user vehicle passes the route sequence.

For example, the remaining time until the emergency vehicle passes the route sequence may be determined based on an average speed of the emergency vehicle and a remaining distance of a forward section before the emergency vehicle passes the route sequence.

For example, the ETA to the destination may be generated by acquiring an output value by inputting an input value into an artificial intelligence model trained to generate prediction information of the ETA as the output value by using the number of lanes of a road on which the user vehicle is driving, a section length, a remaining traffic volume, a forward traffic condition, and the maximum traffic capacity during a normal condition as the input value.

For example, the artificial intelligence model may be any one of a random forest model, a time-series data-based Long Short Memory (LSTM) model, or a spatio-temporal network-based transformer model.

Meanwhile, according to an aspect of the present disclosure, there is provided an apparatus for providing an emergency vehicle response plan, the apparatus including: a communication part configured to receive a destination route and current location information from a user vehicle and to receive current location information, a route sequence, traffic information of an emergency vehicle from an emergency vehicle server; and a controller configured to determine whether a route of the user vehicle and a route of the emergency vehicle overlap based on the destination route and the current location information of the user vehicle and based on the current location information, the route sequence, and the traffic information of the emergency vehicle, the controller being configured to provide an avoidance route to the user vehicle or to provide a responding driving plan to the user vehicle (e.g., according to whether the user vehicle is capable of using the avoidance route in response that the route of the user vehicle and the route of the emergency vehicle overlap), the responding driving plan being provided based on an Estimated Time of Arrival (ETA) to a destination of the user vehicle and information on an estimated driving lane of the emergency vehicle.

For example, the information on the estimated driving lane of the emergency vehicle may be determined based on sensor information received from a vehicle around the user vehicle.

For example, the controller may be configured to generate an avoidance route in which the user vehicle is capable of reaching the destination while avoiding the emergency vehicle in response that a route for avoiding the emergency vehicle is capable of being used.

For example, whether the route of the user vehicle and the route of the emergency vehicle overlap may be determined based on a first condition regarding whether the user vehicle is located in front of the emergency vehicle on the route sequence of the emergency vehicle.

For example, whether the route of the user vehicle and the route of the emergency vehicle overlap may be determined based on a second condition regarding whether the emergency vehicle is capable of passing the user vehicle before the user vehicle passes the route sequence of the emergency vehicle.

For example, whether the emergency vehicle is capable of passing the user vehicle before the user vehicle passes the route sequence of the emergency vehicle may be determined based on a result of comparing a remaining time until the user vehicle passes the route sequence of the emergency vehicle with a remaining time until the emergency vehicle passes the route sequence.

For example, the remaining time until the user vehicle passes the route sequence of the emergency vehicle may be determined based on an average speed of the user vehicle and a remaining distance of a forward section remaining before the user vehicle passes the route sequence.

For example, the remaining time until the emergency vehicle passes the route sequence may be determined based on an average speed of the emergency vehicle and a remaining distance of a forward section before the emergency vehicle passes the route sequence.

For example, prediction information of the ETA may be generated by acquiring an output value by inputting an input value into an artificial intelligence model trained to generate the prediction information of the ETA as the output value by using the number of lanes of a road on which the user vehicle is driving, a section length, a remaining traffic volume, a forward traffic condition, and the maximum traffic capacity during a normal condition as the input value.

For example, the artificial intelligence model may be any one of a random forest model, a time-series data-based Long Short Memory (LSTM) model, or a spatio-temporal network-based transformer model.

As referred to herein, a route sequence of an emergency vehicle includes the route or path the emergency vehicle is travelling to its destination.

According to the present disclosure, a vehicle may include the apparatus for providing the emergency vehicle response plan.

According to various aspects of the present disclosure described above, the influence due to an emergency vehicle in a front section or a rear section of a driving vehicle is provided to a driver and an appropriate response plan is provided, so that the driver's satisfaction and experience are capable of being increased.

In addition, in a situation in which Vehicle-to-Everything (V2X) is stably distributed, information on an emergency vehicle is provided to surrounding vehicles, so that the overall traffic flow of a road is capable of being improved, and a countermeasure for an emergency situation is capable of being realized.

The effects that can be obtained from the present disclosure are not limited to the above-mentioned effects, and other effects not mentioned herein will be clearly understood by those skilled in the art from the following description.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a block diagram schematically illustrating a structure of a system for providing an emergency vehicle response plan according to an embodiment of the present disclosure;

FIG. 2 is an example in which a location of a user vehicle and a location of an emergency vehicle satisfy a first condition according to an embodiment of the present disclosure;

FIG. 3 is an example of a driving lane moving plan of a user vehicle according to an embodiment of the present disclosure;

FIG. 4 is a view illustrating another example of a driving lane moving plan of a user vehicle according to an embodiment of the present disclosure; and

FIG. 5 is a flowchart showing a method for providing an emergency vehicle response plan according to an embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, exemplary embodiments disclosed in the present specification will be described in detail with reference to the accompanying drawings. In the present specification, the same or similar components will be denoted by the same or similar reference numerals, and a repeated description thereof will be omitted. In the following description, the expressions “module” and “part” contained in terms of constituent components to be described will be selected or used together in consideration only of the convenience of writing the following specification, and the expressions “module” and “part” do not necessarily have different meanings or roles. Detailed description of known technologies will be omitted if it is determined that the detailed description of the known technologies obscures the embodiments of the present specification. In addition, the accompanying drawings are merely intended to easily describe the embodiments of the present specification, but the spirit and technical scope of the present specification is not limited by the accompanying drawings. It should be understood that the present specification is not limited to specific disclosed embodiments, but includes all modifications, equivalents and substitutes included within the spirit and technical scope of the present disclosure.

Terms including ordinals such as “first” or “second” used herein may be used to describe various components, but the components are not limited by the terms. The terms are used only for the purpose of distinguishing one constituent element from another constituent element.

When a component is described as being “connected”, “coupled”, or “linked” to another component, that component may be directly connected, coupled, or linked to that other component. However, it should be understood that yet another component between each of the components may be present. In contrast, it should be understood that when a component is referred to as being “directly coupled” or “directly connected” to another component, there are no intervening components present.

Singular expressions include plural expressions unless the context clearly indicates otherwise.

It is to be understood that terms such as “including”, “having”, and so on are intended to indicate the existence of the features, numbers, steps, actions, elements, components, or combinations thereof disclosed in the specification, and are not intended to preclude the possibility that one or more other features, numbers, steps, actions, elements, components, or combinations thereof may exist or may be added.

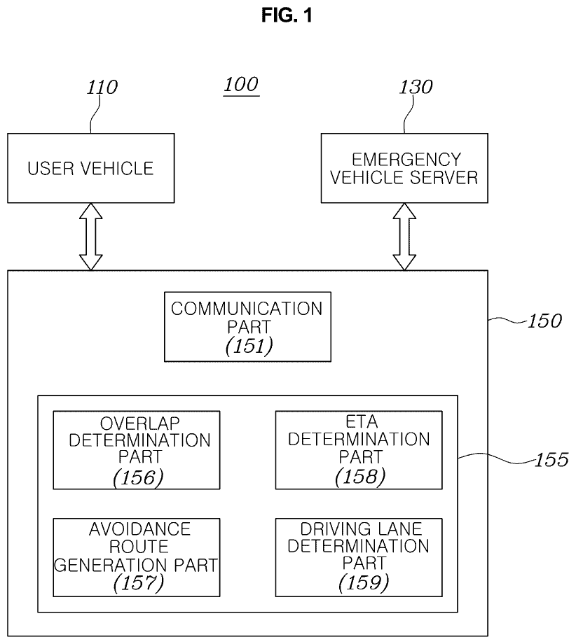

FIG. 1 is a block diagram schematically illustrating a structure of a system for providing an emergency vehicle response plan according to an embodiment of the present disclosure.

Referring to FIG. 1, a system 100 for providing an emergency vehicle response plan according to the present embodiment includes a user vehicle 110, an emergency vehicle server 130, and a control server 150.

The user vehicle 110 is a target vehicle configured to receive an emergency vehicle response plan and an Estimated Time of Arrival (ETA) to a destination from the control server 150, and may be one of at least one vehicle that is driven within a predetermined range from an expected movement route of an emergency vehicle.

At this time, the user vehicle 110 may transmit a destination route and current location information to the control server 150 in order to receive information on the emergency vehicle response plan and the ETA to the destination from the control server 150.

In addition, when the user vehicle 110 receives the information on the emergency vehicle response plan from the control server 150, the information on the emergency vehicle response plan is capable of being shared to surrounding vehicles based on Vehicle-to-Everything (V2X).

The emergency vehicle server 130 transmits the current location information, a route sequence, and priority signal control information of the emergency vehicle to the control server 150.

At this time, the priority signal control information may be defined as traffic information.

At this time, the emergency vehicle server 130 may be a server installed in the National Police Agency that controls priority signals of an emergency vehicle and a road.

In the present specification, the “emergency vehicle” is a vehicle that has been given special authority to respond quickly to an emergency situation, and may include, for example, an ambulance, a fire engine, a police vehicle, and so on.

The control server 150 provides the emergency vehicle response plan and the ETA to the destination to the user vehicle 110 based on the information received from the user vehicle 110 and the information received from the emergency vehicle.

The control server 150 includes a communication part 151 and a control part 155.

Each of the above parts (or units) may constitute modules and/or devices of the control server 150, which may be a controller. For example, the above parts of the control server 150 may constitute hardware components that form part of a controller (e.g., modules or devices of a high-level controller), or may constitute individual controllers each having a processor and memory. The control server 150 may include one or more processors and memory.

The communication part 151 receives the destination route and the current location information from the user vehicle 110, receives the current location information, the route sequence, and the priority signal control information of the emergency vehicle from the emergency vehicle server 130, and transmits at least one of an emergency vehicle avoidance route, the information on the emergency vehicle response plan or the ETA to the destination, or a combination thereof to the user vehicle 110.

In addition, the communication part 151 may receive a rear image and radar sensor information from surrounding vehicles within a predetermined radius from the user vehicle 110 and may provide the rear image and the radar sensor information to the control part 155.

The control part 155 generates the information on the emergency vehicle response plan and the ETA to the destination based on the destination route and the current location information of the user vehicle 110 and based on the current location information and the priority signal control information of the emergency vehicle received from the emergency vehicle server 130.

The control part 155 includes an overlap determination part 156, an avoidance route generation part 157, an ETA determination part 158, and a driving lane determination part 159.

The overlap determination part 156 determines whether the route of the user vehicle 110 and the route of the emergency vehicle are overlapped based on the destination route and the current location information of the user vehicle 110 and the current location information and the priority signal control information of the emergency vehicle.

Here, the overlap of the routes of the user vehicle 110 and the emergency vehicle means that it is impossible for the user vehicle 110 to drive while avoiding the emergency vehicle.

At this time, the overlap determination part 156 may determine that the routes of the user vehicle 110 and the emergency vehicle overlap when both a first condition and a second condition that are for determining whether the routes of the user vehicle 110 and the emergency vehicle overlap are satisfied.

At this time, the first condition may be determined to be satisfied when the user vehicle 110 is located in front of the emergency vehicle in the route sequence of the emergency vehicle.

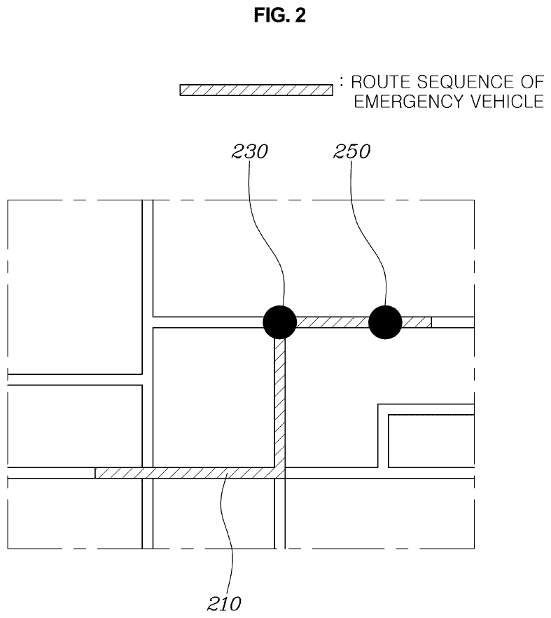

For example, referring to FIG. 2, the first condition may be determined to be satisfied when the user vehicle 110 is present in a second position 250 that is in front of a first position 230 that is the current position of the emergency vehicle in a route sequence 210 of the emergency vehicle.

In the present specification, the route sequence of the emergency vehicle indicates a route in which the emergency vehicle is expected to be driven, and may be determined based on the current location information and the priority signal control information of the emergency vehicle.

At this time, the second condition may be determined to be satisfied when the emergency vehicle may pass the user vehicle 110 before the user vehicle 110 passes the route sequence of the emergency vehicle.

At this time, when a remaining time until the user vehicle 110 passes the route sequence of the emergency vehicle is longer than a remaining time until the emergency vehicle passes the route sequence, it may be determined that the emergency vehicle 110 may pass the user vehicle 110 before the user vehicle 110 passes the route sequence of the emergency vehicle.

At this time, the remaining time until the user vehicle 110 passes the route sequence of the emergency vehicle may be determined based on an average speed of the user vehicle 110 and a remaining distance of a forward section remaining until the user vehicle 110 passes the route sequence.

At this time, the remaining time until the emergency vehicle passes the route sequence may be determined based on an average speed of the emergency vehicle and a remaining distance of a forward section remaining before the emergency vehicle passes the route sequence.

Referring to FIG. 1 again, when the routes of the user vehicle 110 and the emergency vehicle overlap, the overlap determination part 156 requests the avoidance route generation part 157 to determine whether the user vehicle 110 is capable of driving by avoiding the emergency vehicle and to generate an avoidance route.

In addition, when the user vehicle 110 is unable to avoid the emergency vehicle, the avoidance route generation part 157 transmits a request for generating ETA prediction information for the user vehicle 110 to the ETA determination part 158, and transmits a request for generating information about a driving lane driving plan of the user vehicle 110 to the driving lane determination part 159.

In the present specification, the ETA prediction information refers to information that predicts the time remaining until the user vehicle 110 arrives at the destination.

When the user vehicle 110 is capable of avoiding the emergency vehicle, the avoidance route generation part 157 generates an avoidance route based on the destination route and the current location information of the user vehicle 110 and the current location information and the priority signal control information of the emergency vehicle, wherein the avoidance route is a route in which the user vehicle 110 is capable of avoiding the emergency vehicle and reaching the destination.

When the ETA determination part 158 receives the request for generating the ETA from the avoidance route generation part 157, the ETA determination part 158 generates the ETA prediction information for the user vehicle 110.

At this time, the ETA determination part 158 may generate the ETA prediction information by inputting an input value into an artificial intelligence model trained to generate the ETA prediction information as an output value by using the number of lanes of a road on which the user vehicle 110 is driving, a section length, a remaining traffic volume, a forward traffic condition, and the maximum traffic capacity during a normal condition as the input value.

At this time, the artificial intelligence model may be any one of, but is not limited to, a random forest model, a time-series data-based Long Short Memory (LSTM) model, or a spatio-temporal network-based transformer model.

At this time, the random forest model is one of machine learning algorithms, and is an ensemble learning method in which several decision trees are combined to improve the prediction performance.

At this time, the time-series data-based LSTM model is a deep learning model used to predict a future value based on past data.

At this time, the LSTM is a type of Recurrent Neural Network (RNN), and the LSTM model is a model suitable for processing a long time dependency.

At this time, the spatio-temporal network-based transformer model is a deep learning model used to process and predict spatio-temporal data (data that changes according to time and space). The spatio-temporal network-based transformer model is based on a transformer architecture, and may simultaneously process time-series data and spatial data.

The driving lane determination part 159 requests a rear image and radar sensor information from surrounding vehicles within the predetermined radius of the user vehicle 110, acquires information on whether the emergency vehicle has approached the user vehicle within a predetermined distance of the user vehicle and information on a driving lane of the emergency vehicle based on the rear image and the radar sensor information received from the surrounding vehicles in response to the request, and generates a driving lane moving plan of the user vehicle 110 based on the driving lane of the emergency vehicle and the driving lane of the user vehicle 110.

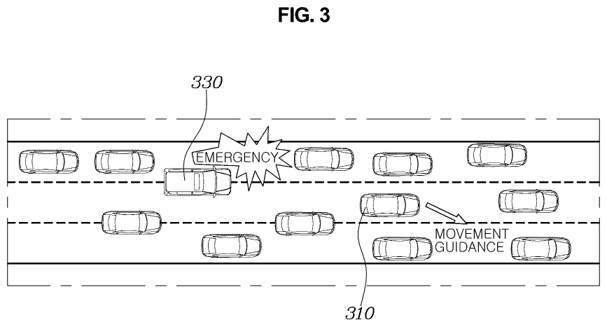

For example, as illustrated in FIG. 3, when an emergency vehicle 330 that is driving in rear of a user vehicle 310 that is driving a second lane on a road with three lanes approaches from the middle of first and second lanes, the driving lane determination part 159 may generate moving plan information that guides the user vehicle 310 to move to the middle of second and third lanes.

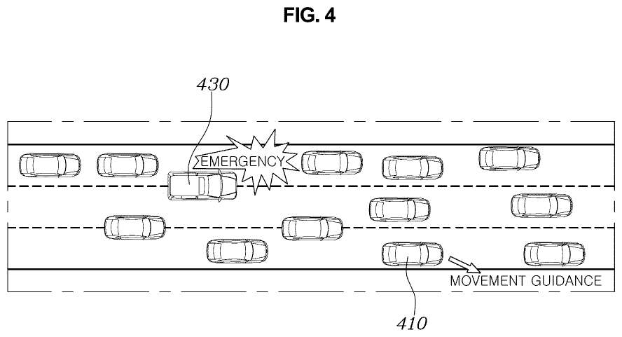

As another example, referring to FIG. 4, when an emergency vehicle 430 that is driving in rear of a user vehicle 410 that is driving a third lane on a road with three lanes approaches from the middle of first and second lanes, the driving lane determination part 159 may generate moving plan information that guides the user vehicle 410 to move to the outer edge of the third lane.

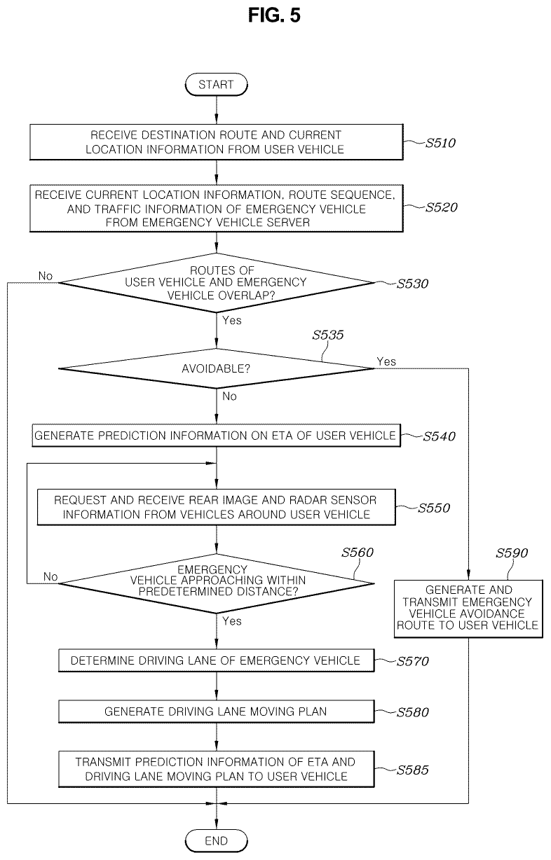

FIG. 5 is a flowchart showing a method for providing an emergency vehicle response plan according to an embodiment of the present disclosure.

A method for providing an emergency vehicle response plan according to the present embodiment may be performed by the control server 150 illustrated in FIG. 1.

Referring to FIG. 5, the control server 150 receives a destination route and current location information from the user vehicle 110 (S510), and receives current location information, a route sequence, and priority signal control information of the emergency vehicle from the emergency vehicle server 130 (S520).

In addition, the control server 150 determines whether a route of the user vehicle 110 and a route of the emergency vehicle are overlapped based on the destination route and the current location information of the user vehicle 110 and the current location information and the priority signal control information of the emergency vehicle (S530).

Here, the overlap of the routes of the user vehicle 110 and the emergency vehicle means that it is impossible for the user vehicle 110 to drive while avoiding the emergency vehicle.

At this time, the control server 150 may determine that the routes of the user vehicle 110 and the emergency vehicle overlap when both the first condition and the second condition for determining whether the routes of the user vehicle 110 and the emergency vehicle overlap are satisfied.

At this time, the first condition may be determined to be satisfied when the user vehicle 110 is located in front of the emergency vehicle in the route sequence of the emergency vehicle.

For example, referring to FIG. 2, the first condition may be determined to be satisfied when the user vehicle 110 is present in the second position 250 that is in front of the first position 230 that is the current position of the emergency vehicle in the route sequence 210 of the emergency vehicle.

At this time, the second condition may be determined to be satisfied when the emergency vehicle may pass the user vehicle 110 before the user vehicle 110 passes the route sequence of the emergency vehicle.

At this time, when the remaining time until the user vehicle 110 passes the route sequence of the emergency vehicle is longer than the remaining time until the emergency vehicle passes the route sequence, it may be determined that the emergency vehicle 110 may pass the user vehicle 110 before the user vehicle 110 passes the route sequence of the emergency vehicle.

At this time, the remaining time until the user vehicle 110 passes the route sequence of the emergency vehicle may be determined based on the average speed of the user vehicle 110 and the remaining distance of the forward section remaining until the user vehicle 110 passes the route sequence.

At this time, the remaining time until the emergency vehicle passes the route sequence may be determined based on the average speed of the emergency vehicle and the remaining distance of the forward section remaining before the emergency vehicle passes the route sequence.

Meanwhile, the control server 150 determines whether the user vehicle 110 is capable of avoiding the driving route of the emergency vehicle. Furthermore, when the control server 150 determines that the user vehicle 110 is not capable of avoiding the driving route of the emergency vehicle, the control server 150 generates ETA prediction information for the user vehicle 110 (S540).

In the present specification, the ETA prediction information refers to information that predicts the time remaining until the user vehicle 110 arrives at the destination.

At this time, the control server 150 may generate the ETA prediction information by inputting an input value into an artificial intelligence model trained to generate the ETA prediction information as an output value by using the number of lanes of a road on which the user vehicle 110 is driving, a section length, a remaining traffic volume, a forward traffic condition, and the maximum traffic capacity during a normal condition as the input value.

At this time, the artificial intelligence model may be any one of, but is not limited to, a random forest model, a time-series data-based Long Short Memory (LSTM) model, or a spatio-temporal network-based transformer model.

At this time, the random forest model is one of machine learning algorithms, and is an ensemble learning method in which several decision trees are combined to improve the prediction performance.

At this time, the time-series data-based LSTM model is a deep learning model used to predict a future value based on past data.

At this time, the LSTM is a type of Recurrent Neural Network (RNN), and the LSTM model is a model suitable for processing a long time dependency.

At this time, the spatio-temporal network-based transformer model is a deep learning model used to process and predict spatio-temporal data (data that changes according to time and space). The spatio-temporal network-based transformer model is based on a transformer architecture, and may simultaneously process time-series data and spatial data.

In addition, the control server 150 requests a rear image and radar sensor information from surrounding vehicles within the predetermined radius of the user vehicle 110, and receives the rear image and the radar sensor information received from the surrounding vehicles in response to the request (S550).

In addition, the control server 150 determines whether the emergency has approached the user vehicle within the predetermined distance of the user vehicle based on the rear image and the radar sensor information of the surrounding vehicles (S560). Furthermore, when the control server 150 determines that the emergency vehicle has approached the user vehicle 110 within the predetermined distance of the user vehicle 110, the control server 150 determines a driving lane of the emergency vehicle (S570), generates information on a driving lane moving plan of the user vehicle 110 based on the driving lane of the emergency vehicle and a driving lane of the user vehicle 110 (S580), and transmit the ETA prediction information and the information on the driving lane moving plan to the user vehicle 110 (S585).

Meanwhile, when a determination result of the process S535 indicates that the user vehicle 110 is capable of avoiding the driving route of the emergency vehicle, the control server 150 generates an avoidance route based on the destination route and the current location information of the user vehicle 110 and based on the current position information and the priority signal control information of the emergency vehicle and transmits the avoidance route to the user vehicle 110 (S590), wherein the avoidance route is a route in which the user vehicle 110 is capable of avoiding the emergency vehicle and reaching the destination.

According to embodiments of the present disclosure described above, the influence due to an emergency vehicle in a front section or a rear section of a driving vehicle is provided to a driver and an appropriate response plan is provided, so that the driver's satisfaction and experience are capable of being increased.

In addition, in a situation in which the V2X is stably distributed, information on an emergency vehicle is provided to surrounding vehicles, so that the overall traffic flow of a road is capable of being improved, and a countermeasure for an emergency situation is capable of being realized.

The present disclosure described above may be embodied as a computer-readable code on a medium in which a program is recorded. A computer-readable medium includes all types of recording devices in which data readable by a computer system is stored. Examples of the computer-readable medium include a Hard Disk Drive (HDD), a Solid-State Drive (SSD), a Silicon Disk Drive (SDD), a Read-Only Memory (ROM), a Random-Access Memory (RAM), a CD-ROM, a magnetic tape, a floppy disk, an optical data storage device, and so on. Therefore, the foregoing detailed description should not be construed as restrictive but be considered illustrative in all respects. The scope of the present disclosure should be determined by a reasonable interpretation of the appended claims, and all modifications within the equivalent scope of the present disclosure are considered included in the scope of the present disclosure.

What is claimed is:

1. A method for providing an emergency vehicle response plan, the method comprising:
a) determining, by a controller, whether a route of a user vehicle and a route of an emergency vehicle overlap; and
b) providing, by the controller, i) an avoidance route to the user vehicle and/or ii) a responding driving plan to the user vehicle, the responding driving plan being provided based on an Estimated Time of Arrival (ETA) to a destination of the user vehicle.

2. The method of claim 1 wherein overlap of the user vehicle route and emergency vehicle route is determined based on i) a destination route and current location information received from the user vehicle and ii) current location information, a route sequence, and/or traffic information of the emergency vehicle received from an emergency vehicle.

3. The method of claim 1, wherein the responding driving plan being provided is further based on an estimated driving lane of the emergency vehicle which estimated driving lane is determined based on sensor information received from a vehicle around the user vehicle.

4. The method of claim 1, further comprising:
generating an avoidance route in which the user vehicle is capable of reaching the destination while avoiding the emergency vehicle in response that a route for avoiding the emergency vehicle is capable of being used.

5. The method of claim 2, wherein the determining of whether the route of the user vehicle and the route of the emergency vehicle overlap comprises:
determining whether a first condition regarding whether the user vehicle is located in front of the emergency vehicle on the route sequence of the emergency vehicle is satisfied.

6. The method of claim 5, wherein the determining of whether the route of the user vehicle and the route of the emergency vehicle overlap further comprises:
determining whether a second condition regarding whether the emergency vehicle is capable of passing the user vehicle before the user vehicle passes the route sequence of the emergency vehicle is satisfied.

7. The method of claim 6, wherein whether the emergency vehicle is capable of passing the user vehicle before the user vehicle passes the route sequence of the emergency vehicle is determined based on a result of comparing a remaining time until the user vehicle passes the route sequence of the emergency vehicle with a remaining time until the emergency vehicle passes the route sequence.

8. The method of claim 7, wherein the remaining time until the user vehicle passes the route sequence of the emergency vehicle is determined based on an average speed of the user vehicle and a remaining distance of a forward section remaining before the user vehicle passes the route sequence.

9. The method of claim 7, wherein the remaining time until the emergency vehicle passes the route sequence is determined based on an average speed of the emergency vehicle and a remaining distance of a forward section before the emergency vehicle passes the route sequence.

10. The method of claim 1, wherein the ETA to the destination is generated by acquiring an output value by inputting an input value into an artificial intelligence model trained to generate prediction information of the ETA as the output value by using the number of lanes of a road on which the user vehicle is driving, a section length, a remaining traffic volume, a forward traffic condition, and the maximum traffic capacity during a normal condition as the input value.

11. The method of claim 10, wherein the artificial intelligence model is any one of a random forest model, a time-series data-based Long Short Memory (LSTM) model, or a spatio-temporal network-based transformer model.

12. An apparatus for providing an emergency vehicle response plan, the apparatus comprising:
a controller configured to receive a destination route and current location information from a user vehicle and to receive current location information, a route sequence, traffic information of an emergency vehicle from an emergency vehicle server; and
the controller configured to determine whether a route of the user vehicle and a route of the emergency vehicle overlap based on i) destination route and the current location information of the user vehicle and ii) current location information, the route sequence, and/or the traffic information of the emergency vehicle, the controller being configured to provide an avoidance route to the user vehicle or to provide a responding driving plan to the user vehicle, the responding driving plan being provided based on an Estimated Time of Arrival (ETA) to a destination of the user vehicle and information on an estimated driving lane of the emergency vehicle.

13. The apparatus of claim 12, wherein the information on the estimated driving lane of the emergency vehicle is determined based on sensor information received from a vehicle around the user vehicle.

14. The apparatus of claim 12, wherein the controller is configured to generate an avoidance route in which the user vehicle is capable of reaching the destination while avoiding the emergency vehicle in response that a route for avoiding the emergency vehicle is capable of being used.

15. The apparatus of claim 12, wherein whether the route of the user vehicle and the route of the emergency vehicle overlap is determined based on a first condition regarding whether the user vehicle is located in front of the emergency vehicle on the route sequence of the emergency vehicle.

16. The apparatus of claim 15, wherein whether the route of the user vehicle and the route of the emergency vehicle overlap is determined based on a second condition regarding whether the emergency vehicle is capable of passing the user vehicle before the user vehicle passes the route sequence of the emergency vehicle.

17. The apparatus of claim 16, wherein whether the emergency vehicle is capable of passing the user vehicle before the user vehicle passes the route sequence of the emergency vehicle is determined based on a result of comparing a remaining time until the user vehicle passes the route sequence of the emergency vehicle with a remaining time until the emergency vehicle passes the route sequence.

18. The apparatus of claim 17, wherein the remaining time until the user vehicle passes the route sequence of the emergency vehicle is determined based on an average speed of the user vehicle and a remaining distance of a forward section remaining before the user vehicle passes the route sequence.

19. The apparatus of claim 12, wherein prediction information of the ETA is generated by acquiring an output value by inputting an input value into an artificial intelligence model trained to generate the prediction information of the ETA as the output value by using the number of lanes of a road on which the user vehicle is driving, a section length, a remaining traffic volume, a forward traffic condition, and the maximum traffic capacity during a normal condition as the input value, wherein the artificial intelligence model is any one of a random forest model, a time-series data-based Long Short Memory (LSTM) model, or a spatio-temporal network-based transformer model.

20. A vehicle comprising the apparatus of claim 12.
